(19) United States
(12) Patent Application Publication
(10) Pub. No.: US 2026/0168726 A1
(43) Pub. Date: Jun. 18, 2026

(54) CO2 TRANS-CRITICAL FREEZING SYSTEM AND FREEZING METHOD

(71) Applicants: HEFEI DESIGN & RESEARCH INSTITUTE OF COAL INDUSTRY CO., LTD, Hefei (CN); CHINA COAL SPECIAL DRILLING CO.,LTD., Huaibei (CN)

(72) Inventors: Tingting BAO, Hefei (CN); Huidong XU, Hefei (CN); Hai YAN, Hefei (CN); Jiangtao DONG, Hefei (CN); Bin XU, Hefei (CN); Jiezhong LIU, Hefei (CN); Yanqiu QI, Hefei (CN); Yufan HUANG, Hefei (CN); Qiankun MA, Hefei (CN)

(73) Assignees: HEFEI DESIGN & RESEARCH INSTITUTE OF COAL INDUSTRY CO., LTD, Hefei (CN); CHINA COAL SPECIAL DRILLING CO.,LTD., Huaibei (CN)

(21) Appl. No.: 19/533,057

(22) Filed: Feb. 6, 2026

Related U.S. Application Data
(63) Continuation of application No. PCT/CN2024/143650, filed on Dec. 30, 2024.

(30) Foreign Application Priority Data
Oct. 17, 2024 (CN) 202411453291.X

(51) Int. Cl. F25J 1/02; E21D 9/00; F25J 1/00

(52) U.S. Cl. CPC F25J 1/0275; E21D 9/001; F25J 1/0027; F25J 2235/80

(57) ABSTRACT

A CO₂ trans-critical freezing system includes: a freezing subsystem, including a first liquid inlet pipe and a first liquid return pipe arranged above the stratum and configured to convey low-temperature liquid CO₂ to the stratum for stratum freezing construction; a liquefaction subsystem, configured to compress a volume of normal-temperature gaseous CO₂, so that movement of molecules between the gaseous CO₂ is limited and reduced, and the gaseous CO₂ is converted into the low-temperature liquid CO₂; and an inlet and return pipeline subsystem. A CO₂ medium used in the system effectively solves problems of flammability, explosion hazard, high risk, difficult disposal, and environmental pollution caused by liquid ammonia and brine used in conventional freezing construction.

### CROSS-REFERENCE TO RELATED APPLICATIONS

This application is a continuation of International Application No. PCT/CN2024/143650, filed on Dec. 30, 2024, which claims priority to Chinese Patent Application No. 202411453291.X, filed on Oct. 17, 2024. All of the aforementioned applications are incorporated herein by reference in their entireties.

### TECHNICAL FIELD

The present disclosure relates to the technical field of stratum reinforcement of a deep underground space, in particular, to the field of freezing construction of an underground deep space and a shaft passing through an unfavorable stratum such as an aquifer, soft soil, a soft rock, and a broken zone, and in particular, to a CO₂ trans-critical freezing system and a freezing method.

### BACKGROUND

With the rapid development of economy and society, the development and utilization of a deep underground space in cities and the exploitation of deep mineral resources will face unfavorable and complex geological conditions such as groundwater, soft soil, a soft rock, and a broken zone.

At present, various conventional pile foundation construction methods are widely used, but the costs are high, and there are risks and defects in waterproofing performance. There is also a conventional freezing construction method. In the prior art, liquid ammonia and brine are used as media and refrigerants. Because the liquid ammonia used is flammable and explosive, the safety risk is high, it is difficult to dispose a large amount of brine, and the environment is polluted, thereby leading to specific defects in the above freezing construction method in actual construction, and failing to meet requirements of safety, efficiency, and environmental protection.

The above contents are only used to assist in understanding the technical solution of the present disclosure, and do not represent an admission that the above contents are closest to the prior art.

### SUMMARY

An objective of the present disclosure is to solve the above shortcomings and provide a CO₂ trans-critical freezing system and a freezing method.

In order to solve the technical problems, the present disclosure uses the following technical solution. A CO₂ trans-critical freezing system is provided, including:
a freezing subsystem, including a first liquid inlet pipe and a first liquid return pipe arranged above the stratum and configured to convey low-temperature liquid CO₂ to the stratum for stratum freezing construction;
a liquefaction subsystem, configured to compress a volume of normal-temperature gaseous CO₂, so that movement of molecules between the gaseous CO₂ is limited and reduced, and the gaseous CO₂ is converted into the low-temperature liquid CO₂; and
an inlet and return pipeline subsystem, configured to perform liquid return circulation on the low-temperature liquid CO₂ conveyed by the freezing subsystem.

Further, the freezing subsystem further includes:
a plurality of liquid inlet branch pipes, located at a lower part of the first liquid inlet pipe and uniformly arranged, and inserted into the stratum; and
a plurality of liquid return branch pipes, located at a lower part of the first liquid return pipe and uniformly arranged, and sleeved outside the liquid inlet branch pipes at intervals.

Further, the liquefaction subsystem includes:
a storage tank, used as a closed container to store the gaseous CO₂;
a compressor, configured to compress a volume of the gaseous CO₂ inside the storage tank and convert the gaseous CO₂ into the low-temperature liquid CO₂; and
a conduit, arranged between the storage tank and the compressor and configured to uniformly distribute and convey the gaseous CO₂ filled in the storage tank to the compressor.

Further, the inlet and return pipeline subsystem includes:
a second liquid inlet pipe, arranged between the first liquid inlet pipe and the compressor and configured to convey the low-temperature liquid CO₂ compressed and converted by the compressor to the stratum;
a second liquid return pipe, connected with the first liquid return pipe and arranged on the compressor, and configured to return the liquid CO₂ entering the stratum into the compressor; and
a pressurized pump station, arranged on a conveying pipeline of the second liquid inlet pipe and configured to provide a power to convey the liquid CO₂ to the first liquid inlet pipe.

Further, a channel penetrating from top to bottom is correspondingly arranged outside the liquid return branch pipe and on the stratum, and the liquid return branch pipe is accommodated and arranged inside the channel.

A CO₂ trans-critical freezing method is provided, used in the CO₂ trans-critical freezing system, including the following steps:
S1, determining a construction position: according to hydrogeological conditions of a deep underground space to be constructed and a shaft, planning and determining the deep underground space and an area to be frozen around the shaft;
S2, drilling construction: arranging a plurality of channels with the same interval around the planned area to be frozen by using a deep drilling method;
S3, arranging freezing devices: connecting a conduit between a storage tank and a compressor, and then connecting a second liquid inlet pipe and a second liquid return pipe having a pressurized pump station to the compressor, respectively, where the second liquid inlet pipe is communicated with a first liquid inlet pipe, and the second liquid return pipe is communicated with a first liquid return pipe; and
S4, freezing construction: sequentially placing a plurality of liquid return branch pipes welded to the first liquid return pipe in the plurality of arranged channels, then inserting and installing a liquid inlet branch pipe welded to the first liquid inlet pipe in each of the liquid return branch pipes, starting the pressurized pump station to convey low-temperature liquid CO₂ to the channels, freezing an unfavorable stratum around the area to be frozen to form a frozen wall, and ensuring that subsequent excavation construction of the area to be frozen is performed normally.

Further, a device used in the deep drilling method implemented in Step S2 is a drilling rig.

Further, in the deep drilling method in Step S2, the device is calibrated every 5 m to 10 m of drilling progress.

Further, in Step S2, a shape of a plane planned on the area to be frozen is consistent with a shape of a plane formed by the plurality of channels deep-drilled around the area to be frozen.

Further, a difference between cross sections of the liquid return branch pipe and the liquid inlet branch pipe used in Step S4 is larger than a cross-sectional area of the liquid inlet branch pipe.

Compared with the prior art, the present disclosure has the following beneficial effects. The CO₂ medium used in the present disclosure effectively solves problems of flammability, explosion hazard, high risk, difficult disposal, and environmental pollution caused by liquid ammonia and brine used in conventional freezing construction, and meets requirements of safety, efficiency, and environmental protection. The compressed and converted low-temperature liquid CO₂ is also used to freeze and reinforce aquifers and weak strata to form water-resisting layers and temporary supports, thereby effectively preventing water seepage as well as settlement, displacement, and collapse of a wall surface and a base plate, improving stability of an area to be excavated and frozen, and reducing and avoiding risks and defects in waterproofing performance that may occur in other conventional pile foundation construction.

### BRIEF DESCRIPTION OF THE DRAWINGS

The drawings, constituting a part of the present disclosure, are used to provide a further understanding of the present disclosure. The illustrative embodiments of the present disclosure and their descriptions are used to explain the present disclosure, and do not constitute undue limitations on the present disclosure. In the drawings:

FIG. 1 is a schematic diagram of a multi-subsystem distribution structure according to an embodiment of the present disclosure;

FIG. 2 is a schematic diagram of a plane arrangement structure according to an embodiment of the present disclosure;

FIG. 3 is a schematic diagram of a vertical arrangement structure according to an embodiment of the present disclosure;

FIG. 4 is an enlarged diagram of a structure at A in FIG. 3; and

FIG. 5 is a flowchart of a method according to an embodiment of the present disclosure.

### DETAILED DESCRIPTION OF THE EMBODIMENTS

The technical solution in the embodiment of the present disclosure will be described clearly and completely below. Obviously, the described embodiments are only some of the embodiments of the present disclosure, rather than all of the embodiments. The embodiments in the present disclosure and the features in the embodiments can be combined with each other without conflict. Based on the embodiments in the present disclosure, all other embodiments obtained by those skilled in the art without paying creative labor belong to the scope of protection of the present disclosure.

It should be noted that if there is a directional indication (such as up, down, left, right, front, back, and the like) in the embodiment of the present disclosure, the directional indication is only used to explain the relative positional relationship, movement situation, and the like between components in a specific posture. If the specific posture changes, the directional indication may also change accordingly.

In addition, if there are descriptions related to “first” and “second” in the embodiment of the present disclosure, the descriptions related to “first” and “second” are only used for descriptive purposes, and cannot be understood as indicating or implying their relative importance or implicitly indicating the number of indicated technical features. Therefore, the features defined with “first” and “second” may explicitly or implicitly include at least one of these features. In addition, the meaning of “and/or” appearing in the present disclosure includes three parallel solutions, taking “A and/or B” as an example, including Solution A, Solution B, or a solution that meets Solution A and Solution B simultaneously. In addition, “a plurality of” refers to more than two. In addition, the technical solutions of various embodiments may be combined with each other, provided that such combination is achievable by those skilled in the art. When the combination of technical solutions is contradictory or impossible, it should be considered that the combination of technical solutions does not exist and is not within the scope of protection of the present disclosure.

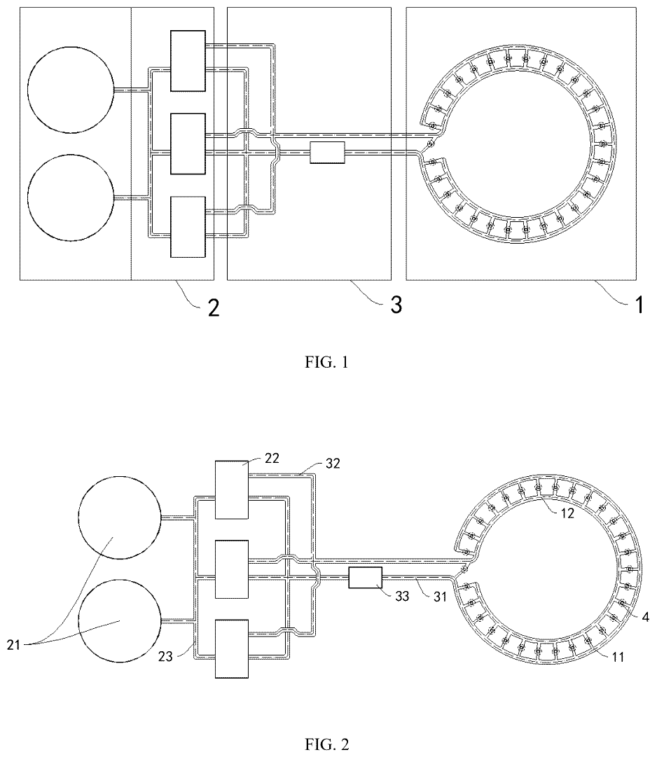

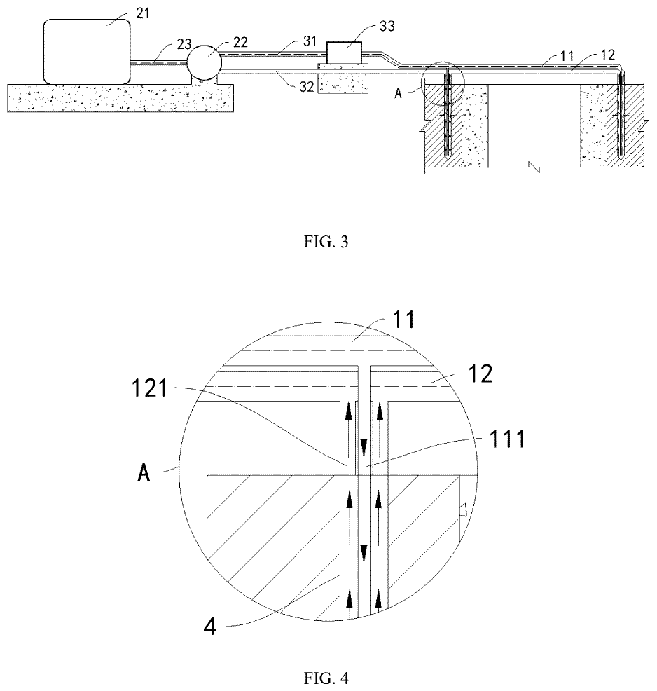

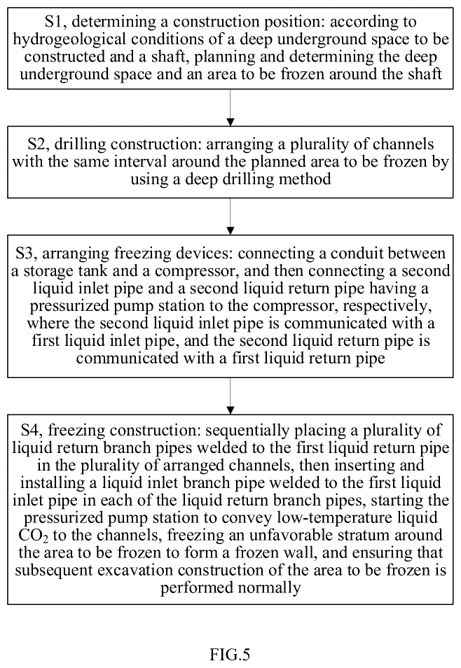

As shown in FIG. 1 to FIG. 5, the present disclosure provides a CO₂ trans-critical freezing system, including:
a freezing subsystem 1, including a first liquid inlet pipe 11 and a first liquid return pipe 12 arranged above the stratum and configured to convey low-temperature liquid CO₂ to the stratum for stratum freezing construction;
a liquefaction subsystem 2, configured to compress a volume of normal-temperature gaseous CO₂, so that movement of molecules between the gaseous CO₂ is limited and reduced, and the gaseous CO₂ is converted into the low-temperature liquid CO₂; and
an inlet and return pipeline subsystem 3, configured to perform liquid return circulation on the low-temperature liquid CO₂ conveyed by the freezing subsystem 1.

In a specific implementation, the liquefaction subsystem 2 converts the normal-temperature gaseous CO₂ into high-pressure and low-temperature liquid CO₂ of −30 degrees to −50 degrees. Through conversion of CO₂ at different pressures and different states, the low-temperature liquid CO₂ is conveyed to the stratum at a target position through the first liquid inlet pipe 11 and the first liquid return pipe 12 included in the freezing subsystem 1 for freezing, a water-resisting layer is formed, and a property of stratum freezing is improved. However, the liquid CO₂ entering the stratum may be returned and be conveyed to the liquefaction subsystem 2 through the inlet and return pipeline subsystem 3, forming a circulating conveying path, ensuring a utilization rate of the liquid CO₂, and preventing the temperature of the conveyed liquid CO₂ from being non-uniform as much as possible.

The first liquid inlet pipe 11 and the first liquid return pipe 12 included in the freezing subsystem 1 are all of annular structures, and a shape of planes of the first liquid inlet pipe 11 and the first liquid return pipe 12 are consistent with a shape of a top opening of the area to be frozen to be constructed.

In an embodiment, the freezing subsystem 1 further includes:
a plurality of liquid inlet branch pipes 111, located at a lower part of the first liquid inlet pipe 11 and uniformly arranged, and inserted into the stratum; and
a plurality of liquid return branch pipes 121, located at a lower part of the first liquid return pipe 12 and uniformly arranged, and sleeved outside the liquid inlet branch pipes 111 at intervals. With this design, a plurality of liquid inlet branch pipes 111 are uniformly welded to a lower surface of the first liquid inlet pipe 11, a plurality of liquid return branch pipes 121 are uniformly welded to a lower surface of the first liquid return pipe 12, and the liquid inlet branch pipes 111 and the liquid return branch pipes 121 in one-to-one positional correspondence are sleeved and combined, so that the low-temperature liquid CO₂ conveyed to the stratum through the liquid inlet branch pipe 111 freezes the stratum, and is returned and be conveyed to the inlet and return pipeline subsystem 3 through the liquid return branch pipe 121, thereby effectively avoiding non-uniform temperature distribution of the conveyed liquid CO₂.

It should be noted that both the liquid inlet branch pipe 111 and the liquid return branch pipe 121 are vertically welded from multi-section steel pipes. Lengths of the liquid inlet branch pipe 111 and the liquid return branch pipe 121 can be determined according to the actual construction conditions, and the construction requirements in a plurality of construction scenarios can be met.

In an embodiment, the liquefaction subsystem 2 includes:
a storage tank 21, used as a closed container to store the gaseous CO₂;
a compressor 22, configured to compress a volume of the gaseous CO₂ inside the storage tank 21 and convert the gaseous CO₂ into the low-temperature liquid CO₂; and
a conduit 23, arranged between the storage tank 21 and the compressor 22 and configured to uniformly distribute and convey the gaseous CO₂ filled in the storage tank 21 to the compressor 22. With this design, two ends of the conduit 23 are connected with the storage tank 21 and the compressor 22, respectively. The storage tank 21 uses more than two rigid closed containers to store the gaseous CO₂. An upper part of the storage tank is provided with a filling device externally connected with the gaseous CO₂ by a ball valve, thereby ensuring sufficient supply of the gaseous CO₂. A lower part of the storage tank is connected with more than three compressors 22 through the conduit 23 with a ball valve structure, so that the compressors 22 can be used to do work and convert the normal-temperature gaseous CO₂ into the high-pressure and low-temperature liquid CO₂ of −30 degrees to −50 degrees.

It should be noted that the number of storage tanks 21 and the number of compressors 22 are determined according to actual construction conditions, thereby ensuring conversion ability of the gaseous CO₂ into the high-pressure and low-temperature liquid CO₂.

In an embodiment, the inlet and return pipeline subsystem 3 includes:
a second liquid inlet pipe 31, arranged between the first liquid inlet pipe 11 and the compressor 22 and configured to convey the low-temperature liquid CO₂ compressed and converted by the compressor 22 to the stratum;
a second liquid return pipe 32, connected with the first liquid return pipe 12 and arranged on the compressor 22, and configured to return the liquid CO₂ entering the stratum into the compressor 22; and
a pressurized pump station 33, arranged on a conveying pipeline of the second liquid inlet pipe 31 and configured to provide a power to convey the liquid CO₂ to the first liquid inlet pipe 11. With this design, the second liquid inlet pipe 31 is welded to the first liquid inlet pipe 11, and an end of the second liquid inlet pipe 31 is connected to a liquid outlet end of the compressor 22 through a ball valve, so that the high-pressure and low-temperature liquid CO₂ can be conveyed in the direction of the first liquid inlet pipe 11 under an action of the combined pressurized pump station 33 connected to the second liquid inlet pipe 31 until the high-pressure and low-temperature liquid CO₂ enters the stratum through a plurality of liquid inlet branch pipes 111 welded to the lower surface of the first liquid inlet pipe 11. The second liquid return pipe 32 is welded to the first liquid return pipe 12, and an end of the second liquid return pipe 32 is connected to a liquid return end of the compressor 22 through a ball valve, so that the liquid CO₂ entering the stratum can be returned and conveyed into the compressor 22 in a circulation manner. In this way, a closed circulation conveying effect is achieved, and the non-uniform temperature distribution of the low-temperature liquid CO₂ conveyed in the stratum can be avoided.

In an embodiment, a channel 4 penetrating from top to bottom is correspondingly arranged outside the liquid return branch pipe 121 and on the stratum, and the liquid return branch pipe 121 is accommodated and arranged inside the channel 4. With this design, a rotary drilling rig is used to perform a deep drilling operation on the stratum and around the area to be frozen, and the depth and the diameter of drilling can fully accommodate the liquid return branch pipe 121. A metal wall surface of the liquid return branch pipe 121 is used for cold and heat exchange, and a soil layer near the channel 4 is frozen to form a frozen wall, thereby achieving the same effect as the pile foundation support, and ensuring the subsequent safe construction operation of the area to be frozen.

A CO₂ trans-critical freezing method is provided, used in the CO₂ trans-critical freezing system, including the following steps:
S1, determining a construction position: according to hydrogeological conditions of a deep underground space to be constructed and a shaft, planning and determining the deep underground space and an area to be frozen around the shaft;
S2, drilling construction: arranging a plurality of channels 4 with the same interval around the planned area to be frozen by using a deep drilling method;
S3, arranging freezing devices: connecting a conduit 23 between a storage tank 21 and a compressor 22, and then connecting a second liquid inlet pipe 31 and a second liquid return pipe 32 having a pressurized pump station 33 to the compressor 22, respectively, where the second liquid inlet pipe 31 is communicated with a first liquid inlet pipe 11, and the second liquid return pipe 32 is communicated with a first liquid return pipe 12; and
S4, freezing construction: sequentially placing a plurality of liquid return branch pipes 121 welded to the first liquid return pipe 12 in the plurality of arranged channels 4, then inserting and installing a liquid inlet branch pipe 111 welded to the first liquid inlet pipe 11 in each of the liquid return branch pipes 121, starting the pressurized pump station 33 to convey low-temperature liquid CO₂ to the channels 4, freezing an unfavorable stratum around the area to be frozen to form a frozen wall, and ensuring that subsequent excavation construction of the area to be frozen is performed normally.

In the specific implementation, the compressors 22 does work through CO₂, and converts the normal-temperature gaseous CO₂ into the high-pressure and low-temperature liquid CO₂ of −30 degrees to −50 degrees. Through conversion of CO₂ at different pressures and different states, the low-temperature liquid CO₂ is conveyed to the stratum to be frozen, thereby improving a property of stratum freezing, and meeting the requirements of construction.

In an embodiment, a device used in the deep drilling method implemented in Step S2 is a drilling rig. This design is suitable for penetrating different types of soil, and the soil is cut by rotating a drill bit to perform a deep drilling operation on the stratum, so that operability is excellent.

In an embodiment, in the deep drilling method in Step S2, the device is calibrated every 5 m to 10 m of drilling progress. With this design, the internal deviation should be strictly controlled, the excessive deviation should be corrected in time, and a borehole deviation map should be drawn in time. The borehole failing to meet the design requirements must be re-drilled as a supplement to ensure accuracy of borehole positions and depths.

In an embodiment, in Step S2, a shape of a plane planned on the area to be frozen is consistent with a shape of a plane formed by the plurality of channels 4 deep-drilled around the area to be frozen. With this design, the surrounding areas can be frozen in a matching manner according to the shape of the plane planned on the area to be frozen, thereby preventing water seepage as well as displacement, settlement, and collapse of a supporting wall in the subsequent construction operation, and improving stability and quality of area to be frozen.

In an embodiment, a difference between cross sections of the liquid return branch pipe 121 and the liquid inlet branch pipe 111 used in Step S4 is larger than a cross-sectional area of the liquid inlet branch pipe 111. With this design, the liquid inlet branch pipe 111 can be sleeved in the liquid return branch pipe 121, and a sufficient accommodation space is left, thereby ensuring that the incoming liquid CO₂ can quickly freeze the soil layer near the channel 4, and ensuring the normal circulation of the liquid return, avoiding the non-uniform temperature of the liquid CO₂, improving freezing efficiency of the liquid CO₂, and having a good use effect.

It is obvious to those skilled in the art that the present disclosure is not limited to the details of the foregoing exemplary embodiments, and the present disclosure can be achieved in other specific forms without departing from the spirit or essential features of the present disclosure. Therefore, the embodiments should be considered in all aspects as exemplary and not restrictive. The scope of the present disclosure is defined by the appended claims rather than the above description. Therefore, it is intended to embrace all changes that fall within the meaning and range of equivalents of the claims in the present disclosure.

What is claimed is:

1. A CO₂ trans-critical freezing system, comprising:
a freezing subsystem, comprising a first liquid inlet pipe and a first liquid return pipe arranged above the stratum and is configured to convey low-temperature liquid CO₂ to the stratum for stratum freezing construction;
wherein the first liquid inlet pipe and the first liquid return pipe included in the freezing subsystem are all of annular structures, and a shape of planes of the first liquid inlet pipe and the first liquid return pipe are consistent with a shape of a top opening of the area to be frozen to be constructed;
wherein the freezing subsystem further comprises:
a plurality of liquid inlet branch pipes, located at a lower part of the first liquid inlet pipe and uniformly arranged, and inserted into the stratum;
a plurality of liquid return branch pipes, located at a lower part of the first liquid return pipe and uniformly arranged, and sleeved outside the liquid inlet branch pipes at intervals;
a liquefaction subsystem, configured to compress a volume of normal-temperature gaseous CO₂, so that movement of molecules between the gaseous CO₂ is limited and reduced, and the gaseous CO₂ is converted into the low-temperature liquid CO₂;
wherein the liquefaction subsystem comprises:
a storage tank, used as a closed container to store the gaseous CO₂;
a compressor, configured to compress a volume of the gaseous CO₂ inside the storage tank and convert the gaseous CO₂ into the low-temperature liquid CO₂; and
a conduit, arranged between the storage tank and the compressor and configured to uniformly distribute and convey the gaseous CO₂ filled in the storage tank to the compressor; and
an inlet and return pipeline subsystem, configured to perform liquid return circulation on the low-temperature liquid CO₂ conveyed by the freezing subsystem;
wherein the inlet and return pipeline subsystem comprises:
a second liquid inlet pipe, arranged between the first liquid inlet pipe and the compressor and configured to convey the low-temperature liquid CO₂ compressed and converted by the compressor to the stratum;
a second liquid return pipe, connected with the first liquid return pipe and arranged on the compressor, and configured to return the liquid CO₂ entering the stratum into the compressor; and
a pressurized pump station, arranged on a conveying pipeline of the second liquid inlet pipe and configured to provide a power to convey the liquid CO₂ to the first liquid inlet pipe.

2. The CO₂ trans-critical freezing system according to claim 1, wherein a channel penetrating from top to bottom is correspondingly arranged outside the liquid return branch pipe and on the stratum, and the liquid return branch pipe is accommodated and arranged inside the channel.

3. A CO₂ trans-critical freezing method, used in the CO₂ trans-critical freezing system according to claim 1, comprising the following steps:
S1, determining a construction position:
according to hydrogeological conditions of a deep underground space to be constructed and a shaft, planning and determining the deep underground space and an area to be frozen around the shaft;
S2, drilling construction:
arranging a plurality of channels with the same interval around the planned area to be frozen by using a deep drilling method;
S3, arranging freezing devices:
connecting a conduit between a storage tank and a compressor, and then connecting a second liquid inlet pipe and a second liquid return pipe having a pressurized pump station to the compressor, respectively, wherein the second liquid inlet pipe is communicated with a first liquid inlet pipe, and the second liquid return pipe is communicated with a first liquid return pipe; and
S4, freezing construction:
sequentially placing a plurality of liquid return branch pipes welded to the first liquid return pipe in the plurality of arranged channels, then inserting and installing a liquid inlet branch pipe welded to the first liquid inlet pipe in each of the liquid return branch pipes, starting the pressurized pump station to convey low-temperature liquid CO₂ to the channels, freezing an unfavorable stratum around the area to be frozen to form a frozen wall, and ensuring that subsequent excavation construction of the area to be frozen is performed normally.

4. The CO₂ trans-critical freezing method according to claim 3, wherein a device used in the deep drilling method implemented in Step S2 is a drilling rig.

5. The CO₂ trans-critical freezing method according to claim 4, wherein in the deep drilling method in Step S2, the device is calibrated every 5 m to 10 m of drilling progress.

6. The CO₂ trans-critical freezing method according to claim 3, wherein in Step S2, a shape of a plane planned on the area to be frozen is consistent with a shape of a plane formed by the plurality of channels deep-drilled around the area to be frozen.

7. The CO₂ trans-critical freezing method according to claim 3, wherein a difference between cross sections of the liquid return branch pipe and the liquid inlet branch pipe used in Step S4 is larger than a cross-sectional area of the liquid inlet branch pipe.
